(19) United States
(12) Patent Application Publication
(10) Pub. No.: US 2018/0034522 A1
(43) Pub. Date: Feb. 1, 2018

(54) METHOD FOR DETERMINING TRANSMIT AND RECEIVE BEAM PATTERNS FOR WIRELESS COMMUNICATIONS NETWORKS

(71) Applicant: BLUWIRELESS TECHNOLOGY LIMITED, Bristol (GB)

(72) Inventor: Mehul MEHTA, Bristol (GB)

(21) Appl. No.: 15/546,872

(22) PCT Filed: Jan. 8, 2016
(86) PCT No.: PCT/GB2016/050039

§ 371 Date: Jul. 27, 2017

(30) Foreign Application Priority Data
Jan. 27, 2015 (GB) 1501364.2
Apr. 29, 2015 (GB) 1507318.2

(51) Int. Cl. H04B 7/06; H04L 1/00; H04L 25/02; H04B 7/08

(52) U.S. Cl. CPC H04B 7/0617; H04B 7/0695; H04B 7/088; H04L 1/0026; H04L 25/0224

(57) ABSTRACT

A method of antenna alignment for a wireless mesh communications network (1) is disclosed. The method is applied to a mesh communications network (1) having a first plurality of communications nodes (2) interconnected by a second plurality of wireless communications links (3).

The present invention relates to wireless communications networks, and in particular to wireless mesh communications networks, including outdoor peer to peer wireless communications networks.

### BACKGROUND OF THE INVENTION

Several wireless communications techniques are being considered for use in outdoor wireless mesh communications networks, including peer to peer communications networks. Communications in the millimetre wave band, for example the 60 GHz frequency band, are of particular interest. In the 60 GHz frequency band, the IEEE (the Institute of Electrical and Electronics Engineers) has proposed that the 802.11ad standard for wireless communications, primarily for indoor networks using the 60 GHz band. Many aspects of the 802.11ad standard are applicable to outdoor networks as well. However, the 802.11ad standard includes beamforming protocols that are not particularly suited for use in an outdoor network.

For example, under the 802.11ad standard specification, it is necessary to use predefined directional antennas which have a much reduced set of possible beam patterns when used over longer ranges common in an outdoor wireless communications networks. Sector-level-sweep (SLS) and related techniques are applicable in high-scattering channels, and are common to indoor solutions.

In contrast, any given outdoor wireless communications channel tends to be dominated by a few strong spatial clusters in which necessary signal strength is available. This strong spatial clustering is caused by diffraction, reflection and blocking of signal paths in the outdoor environment. Coherent interference of these diffracted and reflected paths causes the channel signal to reach the required strength in only a few spatial clusters for a given channel. In order to overcome this high level of spatial clustering, existing systems rely on significant elaborate effort to deploy nodes of a network. Such efforts include expensive site survey, optical alignment equipment and maintenance engineering effort. Such efforts can render deployment of such networks uneconomic. In addition, changing conditions surrounding the nodes of the network are difficult and expensive to overcome or mitigate.

Accordingly, it is desirable to provide a beamforming protocol that is able to work with a few spatial clustered channels and with antennas that are not quasi-omnidirectional in nature. Any such beamforming protocol should ideally operate within the link margin requirements to establish and maintain a link using directional antennas. In millimetre wave systems (for example those operating around the 60 GHz band) an effective beamforming protocol is required in order to establish and maintain necessary link performance.

### SUMMARY OF THE PRESENT INVENTION

According to one aspect of the present invention, there is provided a technique to provide automatic antenna alignment, by providing a beamforming protocol for outdoor wireless communications networks. The technique is particularly suitable for use in wireless mesh communications networks, and also for use in peer to peer communications. Such a technique is suitable for use in millimetre wave communications, such as those that make use of radio frequency communications in the 60 GHz waveband.

One example embodiment of an aspect of the present invention provides automatic link deployment and maintenance; thus significantly reducing time & effort. Such a technique can aid expansion of a network (adding new nodes), can aid adaptation of link parameters to mitigate channel and traffic conditions

An example technique is run-time adaptive; the technique can be optimized from one deployment to another depending on geography, and/or network topology/load. This leads to the highly desirable ‘per deployment’ link adaptation.

Accordingly, an example embodiment of an aspect of the present invention can provide automatic antenna alignment in outdoor peer to peer links, provide a beamforming protocol for outdoor peer to peer links, provide run-time configurable channel access in directional links, and/or provide channel sensitive link adaptation in outdoor peer to peer links. Such techniques are particularly applicable to millimeter wave networks, for example using the 60 GHz band.

### BRIEF DESCRIPTION OF THE DRAWINGS

FIG. 1 illustrates an example mesh communications network;

FIG. 2 illustrates three nodes from the network of FIG. 1;

FIG. 3 illustrates the nodes of FIG. 2 in more detail;

FIG. 4 illustrates a data transfer frame suitable for use in the network of FIG. 1; and

FIG. 5 illustrates an antenna alignment technique for use in the network of FIG. 1.

### DETAILED DESCRIPTION OF PREFERRED EMBODIMENTS

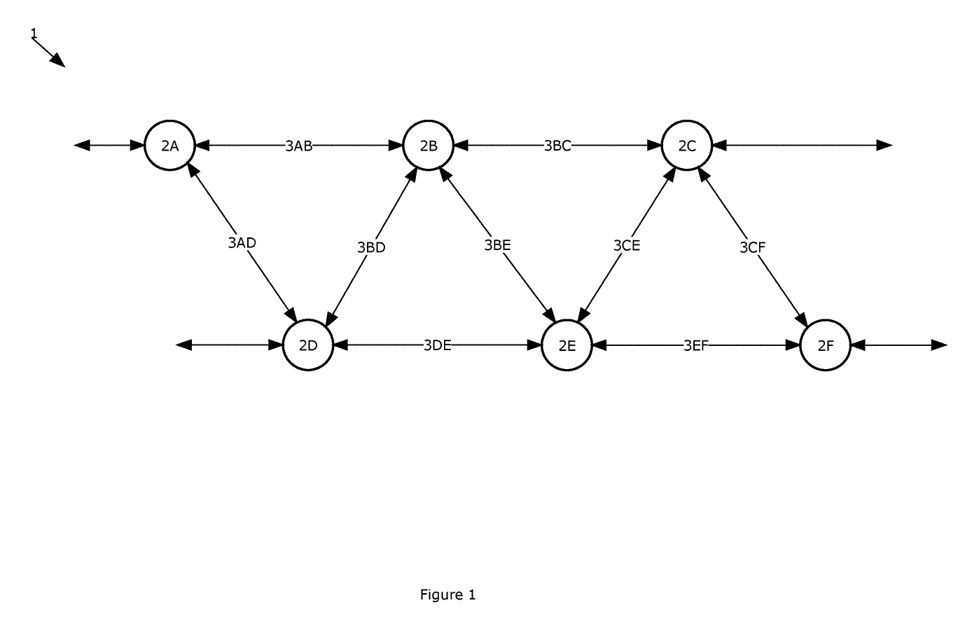

FIG. 1 illustrates an example of a mesh communications network 1, suitable for use in an outdoor environment. The mesh network 1 comprises a plurality of network nodes 2, in this example six nodes 2A to 2F are shown. A plurality of wireless communications links 3, in this example nine 3AB to 3EF, are provided between adjacent nodes 2 on the network. It will be readily appreciated and understood that the network 1 of FIG. 1 is merely exemplary and a mesh network may employ any suitable number of communications nodes 2, with any suitable number of communications links 3 therebetween. The nodes 2 and communications links 3 can be arranged in any suitable manner. In use, data signals are communicated between nodes 2 via the wireless communications links 3 as appropriate to enable transfer of data across the network 1. The wireless communications links 3 make use of radio frequency communications techniques, preferably in the millimetre wave band, for example in the 60 GHz frequency band.

In order to communicate with a specified other node in the network, with the required signal strength whilst using an acceptably low transmission power, a transmitting node must direct its transmissions in an optimal manner towards the target receiving node. Such directional control is achieved by the use of directional antenna arrays.

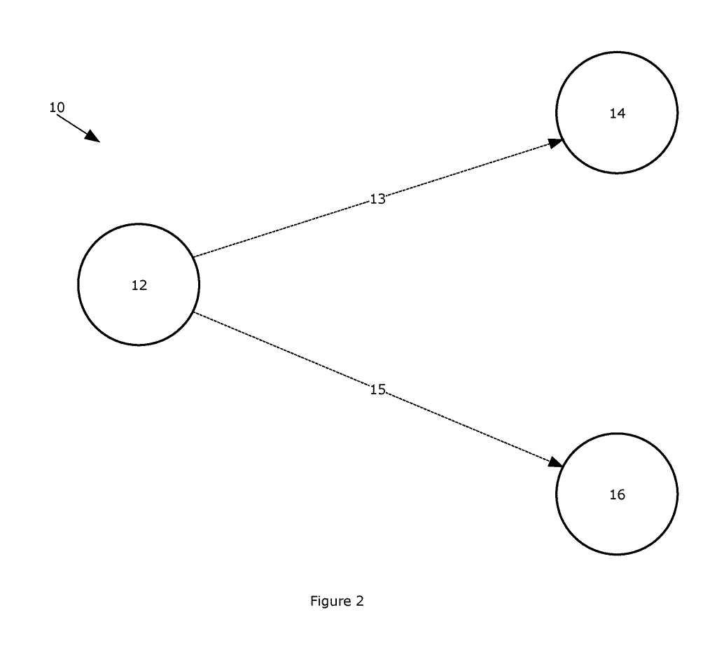

FIG. 2 illustrates a portion 10 of a mesh network in order to demonstrate transmission and reception of data signals. The network portion 10 has a first node 12, a second node 14 and a third node 16. The first and second nodes 12 and 14 are able to communicate over a first communications link 13, and the first and third nodes 12 and 16 are able to communicate over a second communications link 15. In order to communicate with the second node 14, the first node 12 must direct its transmission in a desired direction towards the second node 14. Similarly, in order to communicate with the third node 16, the first node 12 must direct its transmission in a desired direction towards the third node 16. The desired direction may be directly towards the target node, but may also vary from that direction in the event that signal diffraction, reflection, scattering and/or blocking affects the transmission of the data signal from the first node.

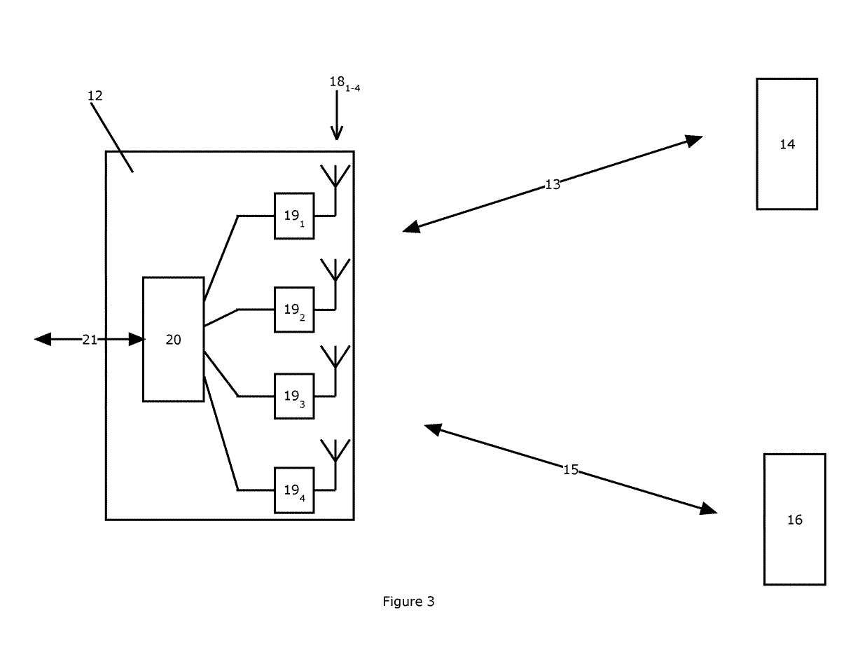

FIG. 3 illustrates the first node 12 of the network portion 10 in more detail. The first node 12 comprises a plurality of antennas 18 (in this example four antennas, 18₁ to 18₄). Each antenna 18 has an associated driver 19 (in this example four drivers 19₁ to 19₄) that provides respective weighted signals for transmission from the antennas 18. The drivers 19 receive control signals and the data signal for transmission from a controller 20, which itself receives control and signal information from other parts of the first node 12. These additional parts are well understood by those skilled in the art, and are omitted here for the sake of clarity.

It will be readily understood that the controller 20 and drivers 19 may be provided by any suitable components, and may be discrete components, or may be partially or completely integrated with any other component(s) of the node 12.

For transmission of a data signal from the first node, the controller 20 supplies the drivers 19 with the data signal to be transmitted together with respective weighting signals. Each driver 19 then transmits an appropriately weighted signal from the associated antenna 18, in order that the beam output from the node 12 is of the appropriate shape and has the appropriate direction. For example, the weightings for directing a signal to the second node 14 along the first link 13 will be different to those used for transmission of a signal to the third node 16 along the second link 15. The weighting provided to each driver relates to a suitable combination of amplitude and phase values for the transmitted signal. The resulting signal transmitted from the antennas 18 is then directed appropriately due to constructive interference of the signals from the individual antennas 18.

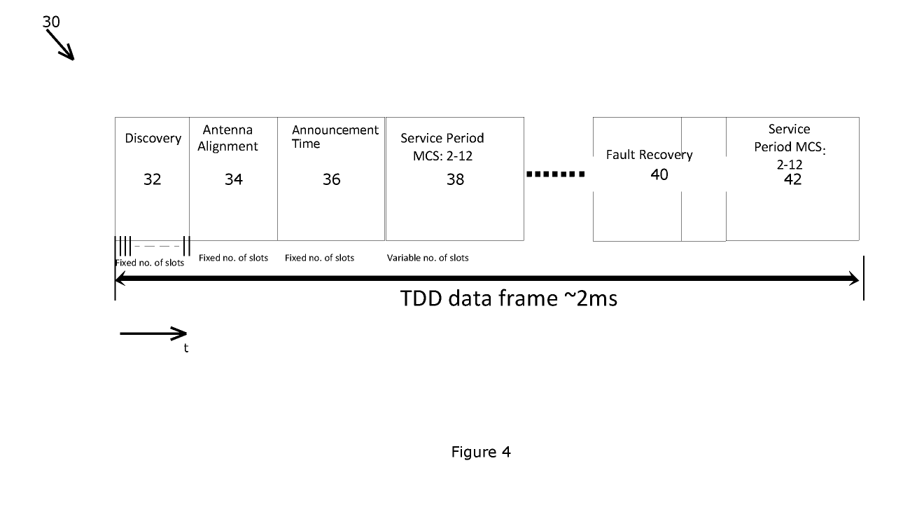

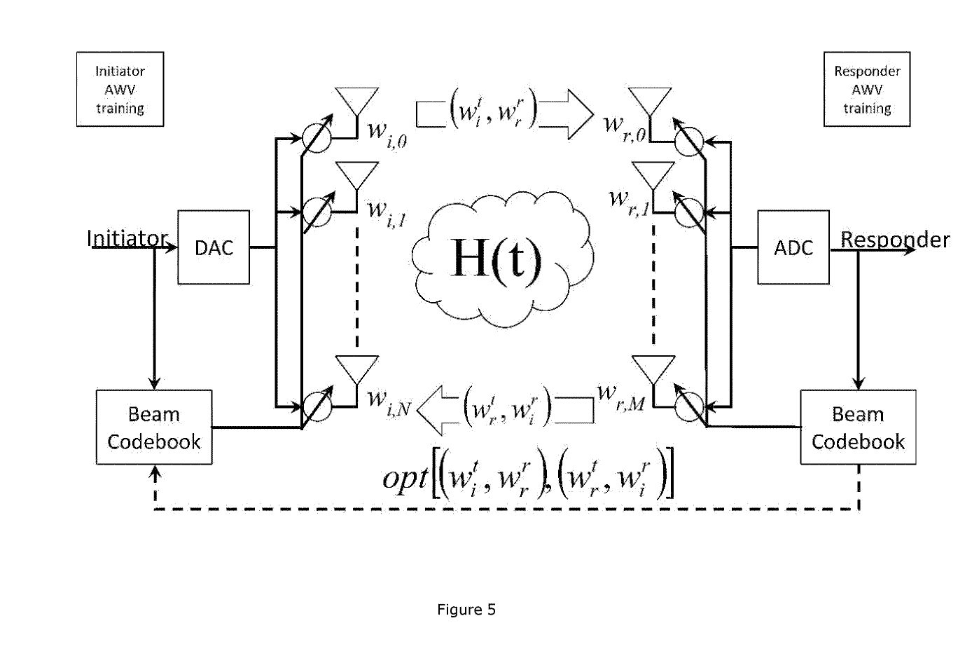

A method embodying an aspect of the present invention provides a technique that enables the appropriate weighting to be supplied to the drivers 19 in order that a signal with the desired signal strength can be transmitted between nodes. In general terms, the controller uses a training data signal in order to determine the correct weightings for the drivers 19. The technique will now be described in more detail with reference to FIGS. 4 and 5.

FIG. 4 illustrates a TDD (time division duplex) data frame 30 for transmission from the first node 12 (also known as the initiator node). The data frame 30 includes a discovery period 32 (also known as a ‘Beaconing Period’) which has a predetermined number of timeslots for data and acknowledgements from new responding nodes. The first node 12 operates to scan through a beam codebook during the beaconing period. The beam codebook provides possible combinations for coding and modulation schemes for transmission of the data signal, and cycling through a range of modulation-coding schemes (MCS) enable a new responding node to register, and allows an update of a location association table upon receipt of the acknowledgement from a responding node.

The data frame 30 then includes a predetermined number of time slots 32 for providing automatic antenna alignment, using initiator and responder antenna weights vector (AWV) training, and establishes optimal beamforming weights pair for each node. This antenna alignment will be described in more detail below.

Following the antenna alignment slots 32, a predetermined number of time slots 36 in the data frame are designated for an announcement time used for management and association frames, capabilities exchange, service period slot allocations, etc.

Following the announcement time period 36, a service period 38 of variable length is provided. It is during this service period 38 that data are transmitted to the receiving node in accordance with the known protocols and techniques.

A fault recovery technique is provided during the service period that makes use of LQI (link quality indicator) triggered antenna re-training in order to re-establish optimal beamforming weights, and renews service period particulars. The fault recovery technique will be described in more detail below. Provision of this fault recovery technique ensures there is no additional data frame overhead and related processing.

Sufficient slots are allocated in the discovery and antenna alignment phases of the data frame 30 so that data throughput is not affected significantly. The number of time slots allocated for each phase is preferably configurable in software. One time slot is sufficient to accommodate the one packet of minimal payload at the lowest MCS (modulation-coding scheme).

There is not the required link margin to function with a ‘quasi-omni’ beam pattern at the responder node in an outdoor network deployment. Therefore, the discovery and alignment process is stepped over several data frames; such that all N beam patterns are toggled at the first node 12 (the initiator node) for one m out of M beam patterns at second node 14 (the responder node). During the discovery period (beaconing period) for the second node 14, the example beaconing technique includes the following steps:

Upon installation and boot, the second node 14 is set to be a responder node, using a default receiver beam codebook index:

wᵣ^{r}(m);m=0,

where wⁱᵣ(m) is the weighting applied to antenna m, in the i^{th} column and r^{th} row of the antenna matrix.

The first node 12 is assigned initiator status, and, at next discovery phase, transmits beacon data, using all beam patterns:

wᵢ^{t}(n)ε{wᵢ^{t}(N)},n=,0,1, [symbol] N−1

where w(n) is the weighting applied to antenna n, in the t^{th} column and i^{th} row of the antenna matrix, for the range of rows 0 to N−1.

Upon detection of the beacon data, the second node 14 transmits an acknowledgement to the first node 12, during a predefined acknowledgement time slot in the beacon period.

If the second node 14 fails to detect a beacon data, the receiving beam for the second node 14 is changed as follows:

wᵣ^{r}(m);m=1,mε{0,1, [symbol] M−1}

Then the second node 14 waits until the next discovery period to attempt to associate with the first node 12.

Upon receiving a valid beacon acknowledgement from the second node 14, the first node 14 invokes the antenna alignment process, as illustrated in FIG. 5.

The first node 12 has a first beam codebook:

wᵢ^{(t,r)}(n)ε{wᵢ^{(t,r)}(N)},n=0,1, [symbol] N−1

Whilst the second node 14 has a second beam codebook:

wᵢ^{(t,r)}(m)ε{wᵢ^{(t,r)}(M)},m=0,1, [symbol] M−1

Wth apriori knowledge of the first and second beam codebooks, the first node 12 transmits channel sounding packets using a first modulation-coding scheme (MCS−0.5) which is suitable for low quality link conditions, and trials through all n initiator beam patterns for the mill beam 10 pattern of the second node 14.

The second node 14 logs received signal strength indicator (RSSI), signal to noise ratio (SNR) and channel impulse response data, and sends an acknowledgement with an ‘optimal’ transmit-receive pair codebook index for every m^{th} trial. These channel sounding metrics are continually updated and stored.

15 It is assumed that the coherence time is greater than the roundtrip duration to complete one trial and responder acknowledgement pair.

A predetermined number of trials (m=M trials) are run in order to determine the following matrices:

$${H}_{RSSI} [ ] , {H}_{SNR} [ ] , {H}_{CSI} [ ]$$

$${H}_{t} = [ \begin{matrix}{w}_{i}^{t} ( 0 ) , {w}_{r}^{r} ( 0 ) & {w}_{i}^{t} ( 1 ) , {w}_{r}^{r} ( 0 ) & & {w}_{i}^{t} ( n ) , {w}_{r}^{r} ( 0 ) \\ {w}_{i}^{t} ( 0 ) , {w}_{r}^{r} ( 1 ) & {w}_{i}^{t} ( 1 ) , {w}_{r}^{r} ( 1 ) & & {w}_{i}^{t} ( n ) , {w}_{r}^{r} ( 1 ) \\ & & & \\ {w}_{i}^{t} ( 0 ) , {w}_{r}^{r} ( m ) & {w}_{i}^{t} ( 1 ) , {w}_{r}^{r} ( m ) & & {w}_{i}^{t} ( n ) , {w}_{r}^{r} ( m )\end{matrix} ] , \\ t ∈ \{ SNR , RSSI , CSI \} , n \leq N - 1 , m \leq M - 1$$

A beamforming cost function is then used to optimize the sounding matrices in order to determine:

opt[(wᵢ^{t},wᵣ^{r})];

that is, the best transmit beam pattern for the first node 12, and the corresponding best receive beam pattern for the second node 14.

The antenna alignment for the first link 13 in the direction from the first node 12 to the second node 14 is then concluded.

Next, the same process is run for the second node 14 in order to determine:

opt[(wᵣ^{t},wᵢ^{r})];

the best transmit beam pattern for the second node 14 and corresponding best receive beam pattern for the first node 12. The antenna alignment for the first link 13 in the direction from the second node 14 to the first node 12 is then concluded.

The optimization function is implemented in the lower MAC (media access control) layer, and channel sounding metrics are maintained by the PHY layer (physical layer).

The data frame 30 next moves onto the announcement time (AT) time slots 36, during which optimal codebook indices are determined for the first and second nodes 12 and 14.

Following the announcement time 36, data signals and acknowledgements can be sent and received over the link 13 during the service period 38. During this period, link adaptation is used to select the most appropriate modulation-coding scheme (MCS) to maintain the desired data rates, signal to noise ratio and other channel metrics.

The service period data transfer frames use SC PHY. The “Last RSSI” field in the header is sent to/from the first/second node 12/14 to maintain LQI (link quality indicator) metrics in the MAC layer. Link Adaptation in the MAC layer ensures optimal use of available MCS and Tx-Rx codebook index to maintain desired performance. The channel metrics used during the antenna alignment process (the logged received signal strength indicator (RSSI), signal to noise ratio (SNR) and channel impulse response data) are stored in combination with the weighting values for use in fault recovery.

If the link 13 experiences a fault that cannot be overcome by link adaptation, then a fault recovery process is put into place. For example, if the link quality indicator (LQI) metric in the MAC layer raises a fault condition, then the service period 40 is interrupted to commence AWV retraining.

In the fault recovery process, the stored channel metrics are used in order that a complete retraining process need not be carried out. Using the stored information, the first and second nodes 12 and 14 can change to a replacement beam pattern pair, based upon the channel metrics stored for that pair. Alternatively, the nodes can switch to the second best beam pattern pair, and then to the third best until acceptable channel metrics are measured.

At each beam pattern pair, different modulation-coding schemes (MCSs) can be applied in order to overcome the link fault condition.

Basing a fault recovery process that relies on known stored beam pattern pairs enables faster recovery from a fault, since it is not necessary to revert to a basic MCS for full retraining.

1. A method of antenna alignment for a wireless mesh communications network having a first plurality of communications nodes interconnected by a second plurality of wireless communications links, the method comprising:
a. determining a first set of transmit beam patterns for an antenna array of a first node of the network;
b. determining a second set of receive beam patterns for an antenna array of a second node of the network;
c. at the first node of the network, following discovery of the second node of the network by the first node, transmitting an antenna training signal to the second node, using a first transmit beam pattern chosen from the first set of transmit beam patterns;
d. at the second node of the network, receiving such a transmitted antenna training signal from the first node using a first receive beam pattern chosen from the second set of receive beam patterns, determining a link quality value for such a transmission, and storing information relating to the transmit beam pattern, the receive beam pattern and the link quality value;
e. repeating steps c and d for a predetermined number of combinations of transmit and receive beam patterns;
f. from such stored information determining a preferred transmit and receive beam pattern pair for transmission of data signals from the first node to the second node.

2. A method of transmitting data signals from a first node of a wireless mesh network to a second node of such a network over a wireless communications link, the method comprising:
a. at the first node of the network, discovering a second node of the network;
b. determining a first set of transmit beam patterns for an antenna array of the first node of the network;
c. determining a second set of receive beam patterns for an antenna array of a second node of the network;
d. at the first node of the network, following discovery of the second node of the network by the first node, transmitting an antenna training signal to the second node, using a first transmit beam pattern chosen from the first set of transmit beam patterns;
e. at the second node of the network, receiving such a transmitted antenna training signal from the first node using a first receive beam pattern chosen from the second set of receive beam patterns, determining a link quality value for such a transmission, and storing information relating to the transmit beam pattern, the receive beam pattern and the link quality value;
f. repeating steps d and e for a predetermined number of combinations of transmit and receive beam patterns;
g. from such stored information, determining a preferred transmit and receive beam pattern pair for transmission of data signals from the first node to the second node;
h. transmitting data signals from the first node to the second node using the determined transmit and receive beam pattern pair.

3. A method as claimed in claim 2, further comprising performing link adaptation during transmission of data signals from the first node to the second node.

4. A method as claimed in claim 2 or 3, further comprising, upon detection of a communications link fault, determining a new transmit and receive beam pattern pair from the stored information.
